(19) United States
(12) Patent Application Publication
(10) Pub. No.: US 2004/0013168 A1
(43) Pub. Date: Jan. 22, 2004

(54) Channel management in adaptive hopping schemes

(75) Inventors: Russell John Haines, Bristol (GB); Michael Philip Fitton, Bristol (GB); Timothy David Farnham, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: TOSHIBA CORPORATION, Tokyo (JP)

(21) Appl. No.: 10/368,490

(22) Filed: Feb. 20, 2003

(30) Foreign Application Priority Data
Feb. 21, 2002 (GB) 0204093.9

(51) Int. Cl. H04B 1/713

(52) U.S. Cl. 375/132

(57) ABSTRACT

An adaptive frequency hopping scheme for use in a predetermined spectrum of communication channels, comprising the steps of setting a monitoring period for each channel while it is in use, detecting the number of damaged or lost transmissions within the monitoring period, marking the channel as “bad” if the detected number is greater than a first predetermined number and then using an alternative channel of the spectrum.

This invention relates to wireless communication systems employing adaptive frequency hopping schemes, in which noisy channels can be substituted by good channels, until such time as the interference on the noisy channels reduces to an acceptable level.

It is known to utilise adaptive frequency hopping, in order to maintain the best possible quality of reception over communication channels, by adapting to an unknown or varying spectral environment in a channel, for example as described in U.S. Pat. No. 6,084,919 (Motorola).

It has also been proposed to provide a “ranking system” in which channels are listed in order of quality, so that a channel can move down the ranking if its quality decreases, or up the ranking if its quality increases (U.S. Pat. No. 5,448,750)

Accordingly, it is possible to reduce the usage of a particular channel, relative to the usage of other available channels, if its quality deteriorates, and conversely, the channel can be reinstated once it has been detected as being clear.

The present invention seeks to provide an improved method of determining the quality of channels, in order to decide how frequently they should be used, and in addition, to provide a method of controlling the manner in which channels are reinstated for use, in accordance with their past performance history.

According to one aspect of the present invention, there is provided an adaptive frequency hopping scheme for use in a predetermined spectrum of communication channels, comprising the steps of setting a monitoring period for each channel while it is in use, detecting the number of damaged or lost transmissions within the monitoring period, marking the channel as “bad” if the detected number is greater than a first predetermined number and then using an alternative channel of the spectrum.

Preferably, the channel is marked as bad as soon as the predetermined number of damaged or lost transmissions has been exceeded, even if this occurs well inside the preset monitoring period.

Preferably, once a channel has been marked as “bad” it may be reinstated after a suitable interval, after which its performance will continue to be monitored, either in accordance with the same parameters as previously, or preferably, in accordance with a stricter set of criteria, i.e. may be placed in a “suspect” category.

Whilst channel is categorised as “suspect”, its performance may be regarded as unsatisfactory, unless its performance has improved, e.g. as soon as a smaller number of transmissions have been lost or damaged within a monitoring period. Preferably, this monitoring time period is shorter, for channels in the suspect category, than for those whose performance is regarded as satisfactory.

When a channel has been categorised as “suspect”, it may be reinstated after a fixed period, but in accordance with a preferred embodiment of the invention, each time a channel is reinstated after having been treated as suspect, the period before reinstatement is increased. It will be appreciated that this preferred reinstatement scheme avoids the system from wasting the effort of frequently reinstating and rejecting a suspect channel, and thereby losing system throughput.

A system of this kind may be employed in various contexts, such as cellphone systems, operating in conjunction with fixed base stations, or “Bluetooth” type systems involving “ad-hoc” networking between a mix of fixed and mobile devices.

Work is underway within the Bluetooth Special Interest Group (SIG) to improve the basic Bluetooth system. There are several working groups within the SIG working on different improvements to the bas: Bluetooth 1.1 standard.

One of these is the coexistence working group, which is concerned with the mutual coexistence within the 2.4 GHz licence exempt band in which Bluetooth operates along with other systems such as IEEE802.11b WiFi systems and baby alarms.

Bluetooth conventionally uses frequency hopping to spread energy around the band, but this is a random hopping process that does not take into account the effects of and on other users of the band.

The proposed solution for the improved Bluetooth system is to adopt adaptive frequency hopping, i.e. to not just pseudo-randomly hop through the 79 channels in the band, but to identify and avoid channels in which other systems are operating. Clearly, these competing systems may not continue to interfere throughout the lifetime of the Bluetooth piconet.

The system of the present invention may be extended to any system adopting an Adaptive Frequency Hopping Scheme.

Firstly, whilst a bad channel may appear to be clear, the interferer may be periodic, or may have only temporarily stopped, i.e. the probability of a bad channel reoffending is high. With this is mind reinstated channels should be considered suspect or “on parole” when first reinstated. Whilst on parole the penalties associated with any lost packets on that channel would be more severe, i.e. whereas a “good” channel may have to lose several packets over a period of time before being considered for replacement, a paroled channel would only have to lose a small number of packets before being replaced again.

The penalties incurred whilst on parole may be increased with each subsequent reoffence; i.e. the number of bad transmissions within a period needed for the channel to be rejected again may be reduced, or the time period within which these bad transmissions must be observed may be extended. This is so that a channel repeatedly susceptible to interference can be rejected even more quickly.

Secondly, if a reinstated channel fails its probation period, a back-off scheme may be adopted so as to further penalise that channel. One preferred scheme is an exponential back-off scheme, where successive reinstatements are spaced further and further apart (e.g. it is tried again after 5s, then 10s, then 20s . . . etc.) In this way if a channel is not getting any better, it is used less and less often before eventually (perhaps) being completely abandoned for the duration of the session.

However, a channel may redeem itself (if, for example, a period passes with no bad transmissions, or there are a pre-requisite number of good transmissions), or it is otherwise established that it is clear. In that case it ceases to be on parole, and is treated in the same way as any other “good” channel.

This back-off scheme may be applied either in a case where channels are reinstated blindly after a period of time (with no attempt to verify that the channel is now free from interference) or where they are tested a number of times before reinstatement (perhaps by transmitting “probe” packets on the channel to test for successful transmission).

Some embodiments of the invention will now be described by way of example, with reference to the accompanying drawings in which:

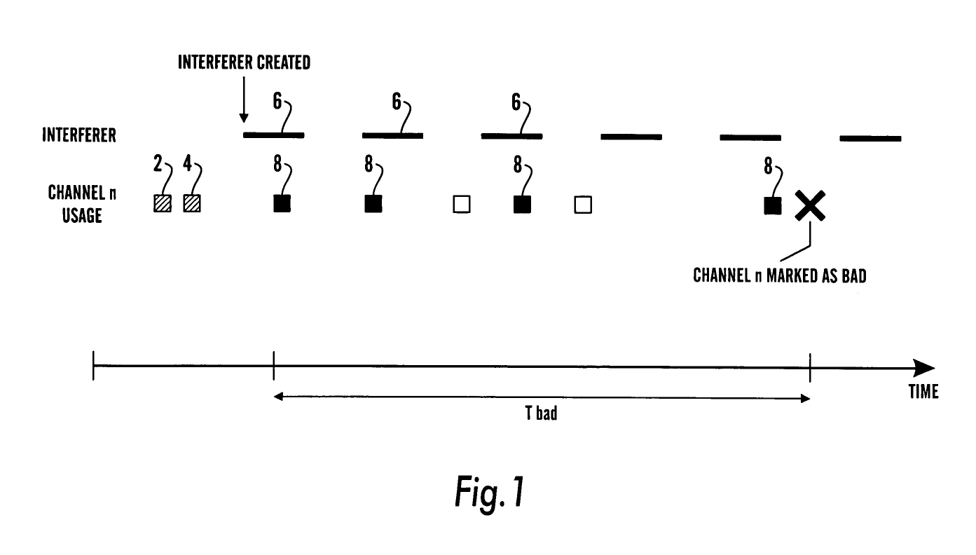

FIG. 1 is a schematic diagram illustrating an initial channel quality assessment process;

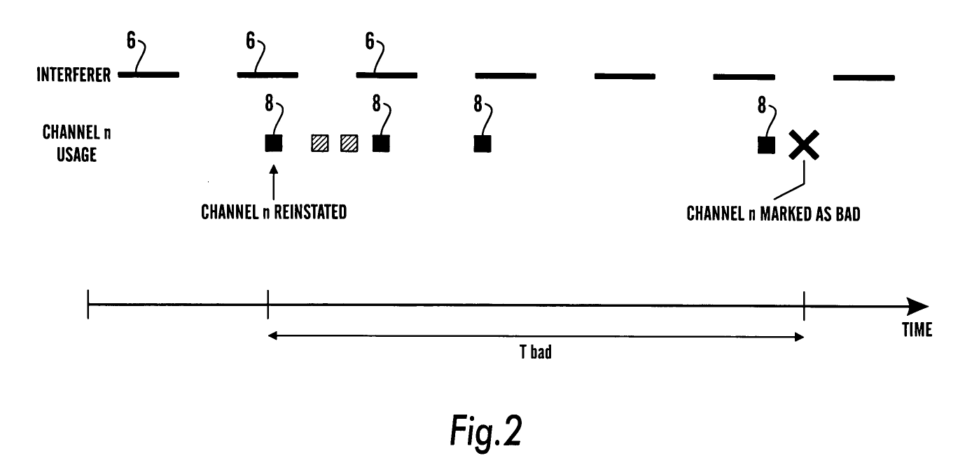

FIG. 2 is a diagram illustrating a channel reinstatement process;

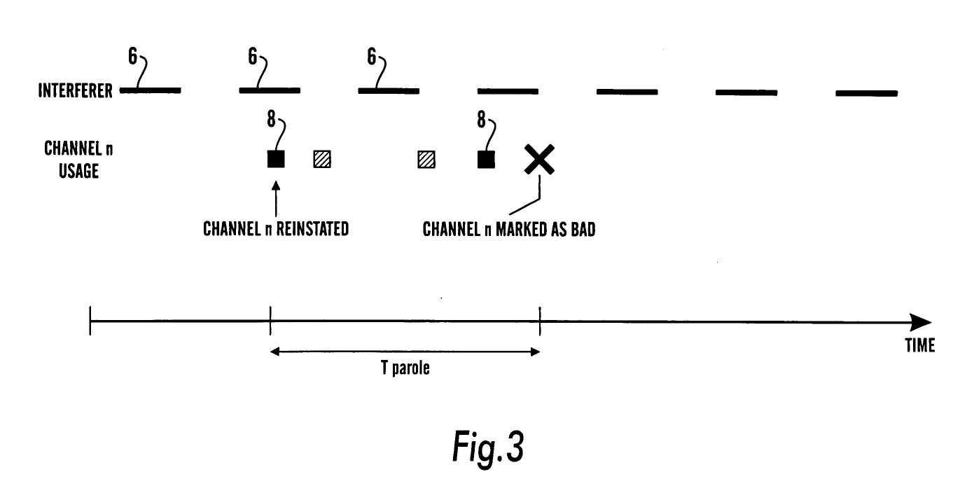

FIG. 3 is a diagram illustrating quality assessment for a reinstated but “suspect” channel; and

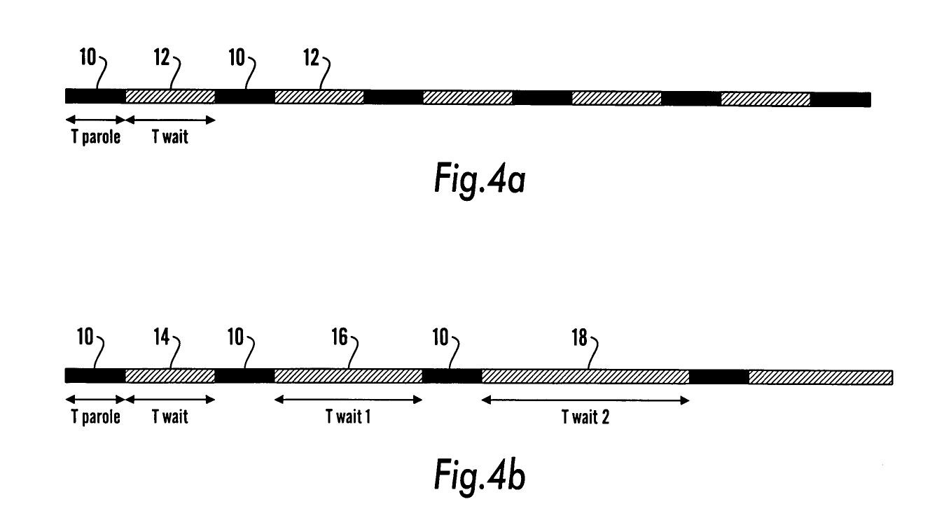

FIG. 4 is a diagram illustrating channel assessment including a reinstatement “back-off” scheme.

Referring to FIG. 1, successive transmissions along a channel are illustrated by blocks 2, 4 etc, whilst a source of periodic interference is indicated by bars 6. In the example shown, the channel is initially monitored for a period “Tbad” shown on the time axis, during which four bad transmissions are detected, which are indicated by the dark shaded transmission blocks 8 in the drawing. As shown, the fourth bad transmissions occurs just before the end of the monitoring period, which is a “worst case scenario”, but in practice, the channel might be marked as “bad” as soon as a certain proportion of transmissions (as illustrated, four out of six) are detected as being bad.

FIG. 2 illustrates a standard “reinstatement” scheme, in which, once again, the channel is monitored for a period “Tbad”, and is again marked bad as a result of the detection of four lost or damaged transmissions, indicated by the dark blocks 8, out of a total of six transmissions.

Clearly, the “standard” reinstatement scheme could involve a considerable number of wasted transmissions, if the interference pattern indicated at 6 were to persist. According, as illustrated in FIG. 3, when a channel has previously been marked as “suspect”, it is preferable placed in a “on parole” category in which it is subject to stricter criteria for being marked as “bad”. As illustrated in FIG. 3, it will be seen that with the interference 6 persisting, bad transmissions 8 will continue to occur as before, but since the channel has been place in the “suspect” category, the monitoring period “Tparole” is now of reduced length, and the channel is marked as bad as soon as two lost or damaged transmissions have been detected.

In the above described example, the channel is reinstated after a fixed period, which can be set simply by a timer. Alternatively, it is envisaged that dummy packets may be transmitted on the channel during the “wait” period, in order to verify lack of interference.

Additionally, instead of being reinstated after a fixed period, the “waiting period” may be successively increased, for a channel which is repeatedly found to be bad. These two possibilities are illustrated diagrammatically in FIG. 4, in which FIG. 4a illustrates successive “parole” periods 10 which are separated by successive “wait” periods 12, during which the channel quality may be reassessed, with each of the periods 12 being equal in length. Alternatively, as illustrated in FIG. 4b, successive wait periods 14, 16, 18 are increased in length, each time the channel has failed during its “parole” period 10. In this way, it is possible to avoid the wastage of resources inherent in the kind of scheme illustrated in FIG. 4a, in which the “bad” channel can be utilised too frequently.

1. An adaptive frequency hopping scheme for use in a predetermined spectrum of communication channels, comprising the steps of setting a monitoring period for each channel while it is in use, detecting the number of damaged or lost transmissions within the monitoring period, marking the channel as “bad” if the detected number is greater than a first predetermined number and then using an alternative channel of the spectrum.

2. An adaptive frequency hopping scheme according to claim 1 in which a channel is marked “bad” as soon as the predetermined number of damaged or lost transmissions has been exceeded.

3. An adaptive frequency hopping scheme according to claim 1 or claim 2 in which a channel which has been marked as “bad” is reinstated for use after a predetermined waiting period.

4. An adaptive frequency hopping scheme according to claim 3 in which a reinstated channel is monitored in accordance with stricter criteria so that it will be marked as “bad” again more quickly unless its performance has improved.

5. An adaptive frequency hopping scheme according to claim 4 in which a reinstated channel is marked as bad as soon as the number of damaged or lost transmissions exceeds a second predetermined number which is less than the first predetermined number.

6. An adaptive frequency hopping scheme according to claim 4 or claim 5 in which the monitoring period is shortened for a reinstated channel.

7. An adaptive frequency hopping scheme according to any one of claims 4 or claim 6 in which the waiting period is progressively increased for a channel which is repeatedly marked as bad.

8. An adaptive frequency hopping scheme according to any one of claims 3 to 7 in which dummy transmissions are made on each “bad” channel during the waiting period in order to determine whether its performance is satisfactory.
